(19) United States
(12) Patent Application Publication
(10) Pub. No.: US 2008/0076097 A1
(43) Pub. Date: Mar. 27, 2008

(54) Kit for manipulating regional spatial data

(76) Inventor: John M. Sherin, Jericho, NY (US)

Correspondence Address: DILWORTH & BARRESE, LLP, 333 EARLE OVINGTON BLVD., SUITE 702, UNIONDALE, NY, 11553, US

(21) Appl. No.: 11/901,771

(22) Filed: Sep. 19, 2007

Related U.S. Application Data
(60) Provisional application No. 60/847,235, filed on Sep. 26, 2006.

(51) Int. Cl. G09B 23/00; A63F 9/08; G09B 29/00

(52) U.S. Cl. 434/150; 273/157 R; 434/153

(57) ABSTRACT

A kit for manipulating regional spatial data includes at least one package for storing a set of materials of said kit; and a set of materials which includes, a map puzzle including a plurality of interlocking jigsaw pieces of predetermined shapes each representing a geopolitical feature, wherein said interlocking pieces are able to be assembled to form a graphic image of a geographic area; a plurality of reusable sticker icons representing persons, places or things, which are releasably attachable to the graphic image of the geographic area to identify the location of the geographic feature; a plurality of reusable text labels each expressing a place name and which are releasably attachable to the graphic image of the geographical area to identify the location of the place; lesson plan(s); and a set of instructions.

### CROSS REFERENCE TO RELATED APPLICATIONS

The present application claims priority to U.S. Provisional Application No. 60/847,235 filed Sep. 26, 2006.

### BACKGROUND

1. Field of the Invention

The present application relates to a kit containing materials and instructions adapted for young students for teaching geography, particularly the manipulation of regional spatial data.

2. Background of the Art

Various tools for teaching geography are known. For example U.S. Pat. No. 6,425,581 discloses a map puzzle game for teaching adults and children to locate political entities of the world on a map. The puzzle pieces include postage stamp reproductions corresponding to specific sites on large format continental and regional outline maps.

U.S. Pat. No. 5,405,140 discloses a family vacation board game employing a geopolitical map of the United States as a game board, with plural playing paths thereacross.

U.S. Pat. No. 5,123,846 discloses a geography game kit designed for teaching the identity and location of counties within a particular state, and other geographical features.

U.S. Pat. No. 5,080,591 discloses an instructional globe having detachable geographic features.

There is yet need for a teaching kit containing complete lessons for 6-10 year old students in a structured group environment to provide a geographically accurate fresh perspective and hands-on experience in manipulating regional spatial data.

### SUMMARY

A kit for manipulating regional spatial data is provided herein. The kit includes (a) at least one package for storing a set of materials of said kit; and (b) a set of materials which includes, a map puzzle including a plurality of interlocking jigsaw pieces of predetermined shapes each representing geopolitical feature, wherein said interlocking pieces are able to be assembled to form a graphic image of persons, places or things, a plurality of reusable sticker icons each representing persons, places or things, which are releasably attachable to the graphic image of the geographic area to identify the location of the geographic feature, a plurality of reusable text labels each expressing a place name which are releasably attachable to the graphic image of the geographical area to identify the location of the place, at least one lesson plan, and at least one set of instructions.

The teaching kit of the invention advantageously provides complete lessons for 6-10 year old individuals in a group environment to provide fresh perspective in manipulating spatial information corresponding to the locality and geographic region in which they reside.

### BRIEF DESCRIPTION OF THE DRAWINGS

Various embodiments are described below with reference to the drawings wherein:

FIG. 1 is a perspective view of a kit for manipulating regional spatial data according to the invention;

FIG. 2 illustrates a map puzzle;

FIG. 3 illustrates a collection of reusable sticker icons; and

FIG. 4 illustrates a collection of reusable text labels.

### DETAILED DESCRIPTION OF PREFERRED EMBODIMENT(S)

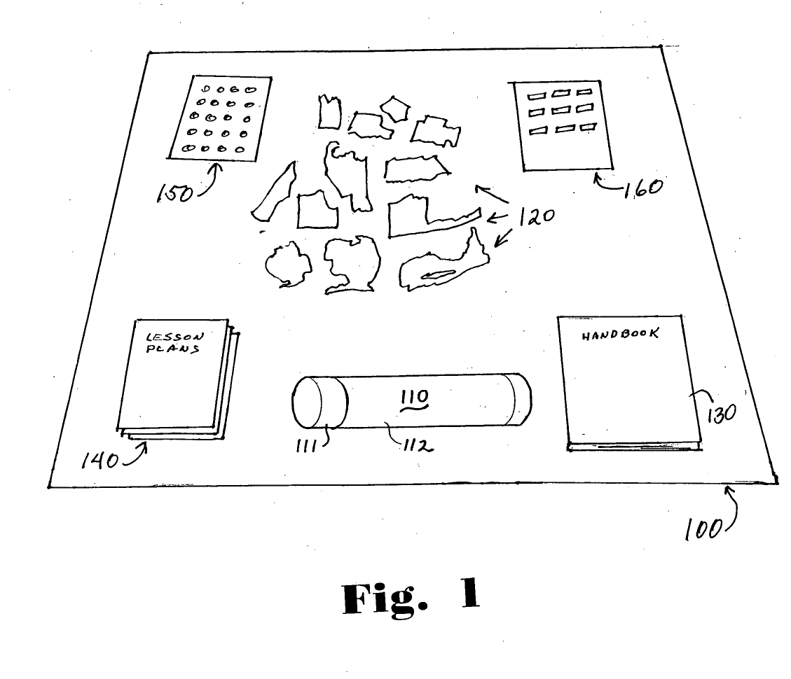

Referring now to FIG. 1, the kit 100 includes a container 110 for storage. The container 110 can be a cylindrical tube having a removable lid 111 and a body 112 made from a transparent material such as clear acrylic or polycarbonate plastic. Alternatively, container 110 can be a rectangular or square shaped box to facilitate stacked storage of the containers 110.

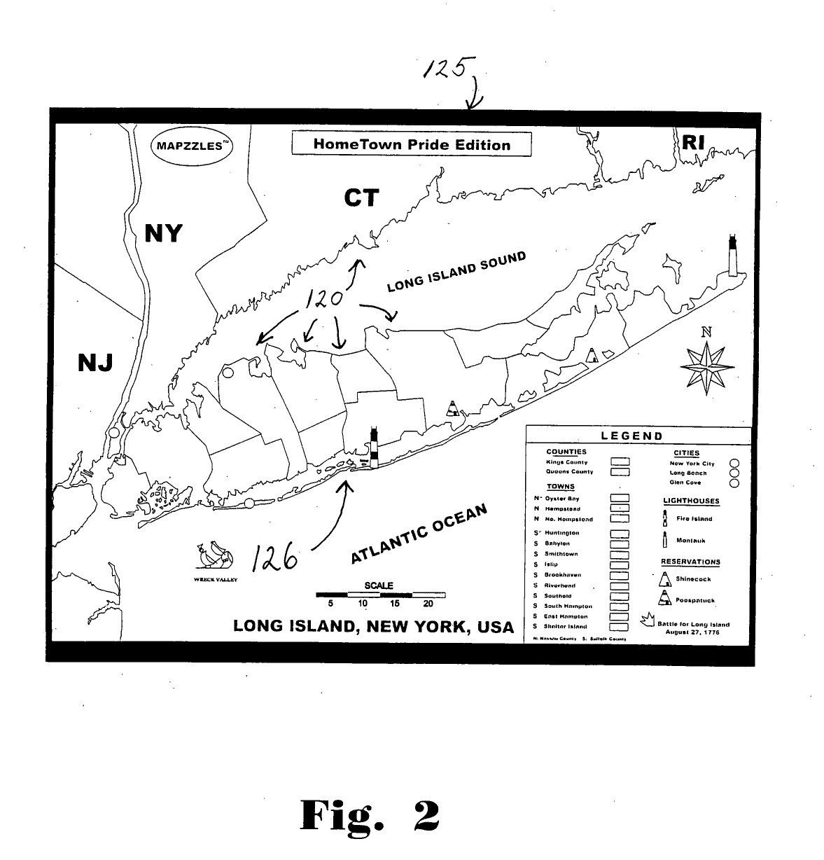

Further, the kit 100 includes a plurality of interlocking pieces 120 in predetermined shapes and optionally of various distinguishing colors, said interlocking pieces representing geopolitical features such as counties, municipalities, designated areas of environmental concern, land use, landmark areas and other officially designated areas. In an embodiment of the invention 108 different pieces are included, although any number of pieces 120 are within the scope of the invention. The kit can further include a template 125 (i.e., a sheet or panel containing outlines of the geographic features corresponding to the interlocking pieces 120) with or without reference to which the interlocking pieces 120 can be fitted together to create a graphic image or map 126 (as shown in FIG. 2) configured as a jigsaw type puzzle and adapted to represent the geographic area.

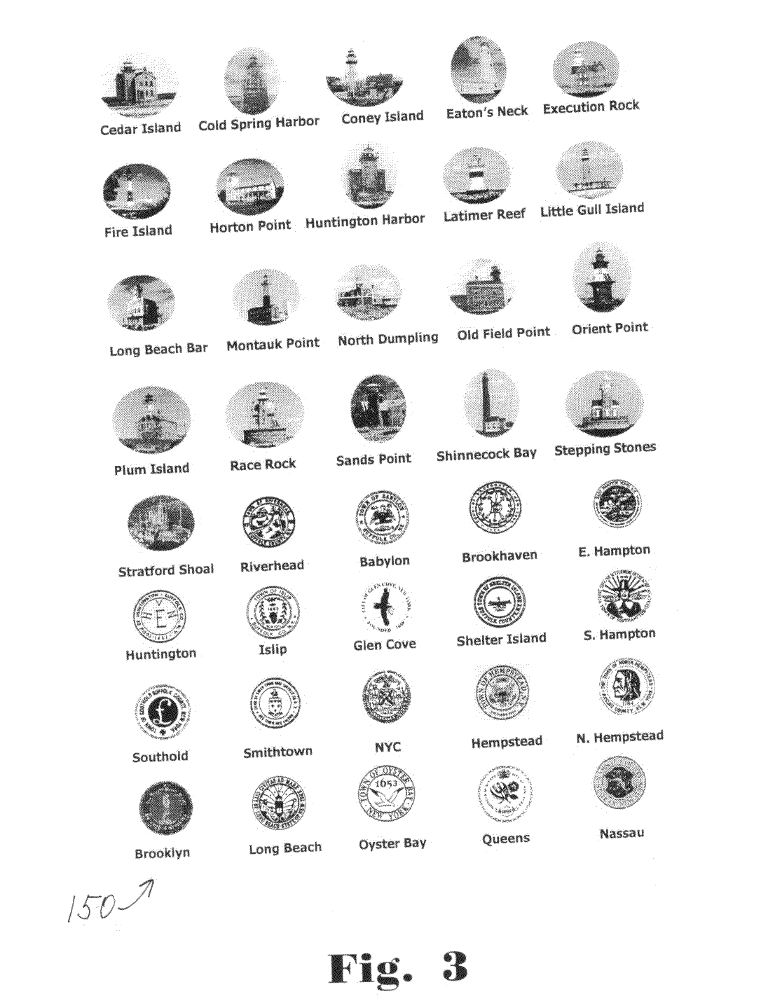

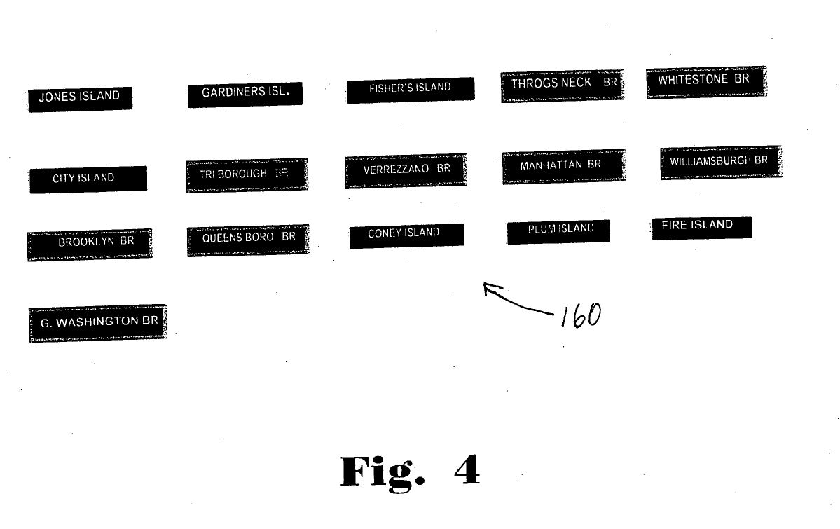

Also included is a handbook 130, lesson plan(s) 140, reusable sticker icons 150 (illustrated in FIG. 3) and reusable text labels 160 representing place names and locations (illustrated in FIG. 4). The handbook 130 provides general instructions for use and facilitation of the kit 100. The lesson plans 140 typically outline procedures for conducting each class in order to achieve specified learning goals. The reusable sticker icons 150 preferably include a pictorial image or symbol representing a particular locale, and can have, for example, a Color Forms® type of clear polyethylene static cling peel-off repositionable sticker to facilitate removable attachment to the map 126 formed by the interlocking pieces 120. The reusable text labels 160 contain place names and can be removably attached to the map 126 formed by the interlocking pieces 120.

The participants complete the map puzzle geographic image 126 in a collaborative effort by assembling the pieces 120 with or without reference to the template 125. The facilitator then gives instructions according to the rules for placing the sticker icons 150 and text labels 160 upon a set of locations on map 126 at a point in time and in a sequence determined by the facilitator.

The continuing use and exposure of the map graphic 126 by the participants during the assembly of the map and subsequent identification and labeling of specific locations on the map helps to create an accurate geo-referenced mental representation of the region and locality in which the participants reside. The kit 100 assures total participation, focusing as it does on cooperation among participants in areas of such important concern as education, housing, transportation, natural disaster preparedness and possible routes of emergency evacuation. Conclusions may differ reflecting a group's collective experience and individual perspective.

### Example

This example presents a sample lesson plan. The plan can be varied and adapted to accommodate various classroom situations.

In the exemplary plan herein, the goal is for the students to assemble four counties and 13 towns by non-verbal means using hands-on manipulative teamwork. The intended outcomes of the exercise include the modeling of successful cooperation, acquisition of useful team-building skills, facilitation of sharing and risk taking behavior, providing emotional distance from personal issues, addressing issues of scarcity and perceptions of insufficiency, building self confidence through self-motivational discovery, identifying practical limits while also exploring municipal boundaries, gaining essential familiarity with local and regional geographic areas, achieving administrative accomplishment through collaborative time on task, and developing mind-mapping methods of negotiation and conflict resolution.

The lesson includes a seven step process:

1. Assign the goal.

2. Optionally, display a picture of the goal completed by providing a representational template 125.

3. Distribute all 108 pieces among the participants. (Steps 1 and 3 may be reversed).

4. Designate a clean flat surface larger than the completed map. Provide access from all sides.

5. Establish the following rules for participant behavior:
i. No talking or signaling to others.
ii. No hitting, pushing or talking away pieces from another.
iii. Give to another participant when what you have fits.

6. Signal to begin. Encourage following the rules.

7. Time the activity or set time limits (e.g., 15 minutes, optional).

The instructor should observe the activity and answer the following questions:

1. Who initiated the activity?

2. Who were the leaders?

3. How were the limits defined?

4. Who provided the last piece?

5. Did border and corner pieces appear first or later?

6. Was the task completed inside-out or outside-in?

7. Was the legend finished before geographic areas were completed?

8. Was anyone unable to contribute?

9. Did you observe conflicts resolved? How?

10. What pattern of cooperation did you see?

11. How could the process have been improved?

12. What else does this activity teach?

Variations can be made to how the activity is structured. For example, the participants can be asked to complete the goal with picture side down and without a clear vision of the mission; they can be asked to assemble corners, top down or using edge pieces first, they can be asked to start with a color focus and assemble outwardly in all directions; the instructor can give an equal number of pieces to each participant or more pieces to some and less to others; the activity can be completed with or without time limits; right handed participants can be asked to use only their left hands and vice versa; each participant can be asked to cover one eye, with no peeking allowed; half the class can be asked to volunteer to be blindfolded during the activity; the map can be assembled one county, town or geographic region at a time.

The activity is structured to heighten the awareness of spatial relationships and to encourage team work on the part of the participants to achieve a common goal

While the above description contains many specifics, these specifics should not be construed as limitations of the invention, but merely as exemplifications of preferred embodiments thereof.

What is claimed is:

1. A kit for manipulating regional spatial data, which comprises:
a) at least one package for storing a set of materials of said kit; and
b) a set of materials which includes,
i. a map puzzle including a plurality of interlocking jigsaw pieces of predetermined shapes each representing geopolitical feature,
ii. a plurality of reusable sticker icons each representing a geographical feature,
iii. a plurality of reusable text labels each expressing a place name,
iv. at least one lesson plan, and
vi. at least one set of instructions.

2. The kit of claim 1 wherein said interlocking pieces are able to be assembled to form a graphic image of a geographic area.

3. The kit of claim 2 wherein then reusable sticker icons are releasably attachable to the graphic image of the geographic area to identify the location of the geographic feature.

4. The kit of claim 3 wherein the reusable text labels are releasably attachable to the graphic image of the geographical area to identify the location of the place.

5. The kit of claim 1 wherein the package includes a cylindrical container.

6. The kit of claim 1 wherein the package includes a rectangular box shaped container.

7. The kit of claim 1 wherein the reusable sticker icons each have a pictorial image or symbol representing a particular locale.

8. The kit of claim 7 wherein the reusable sticker icons are fabricated from a clear polyethylene repositionable static cling material.

9. The kit of claim 1 wherein the lesson plan includes instructions for an activity to be performed by multiple participants.

10. The kit of claim 9 wherein the lesson plan includes the steps of:
assigning a goal,
distributing the jigsaw pieces to the participants, and
establishing rules of behavior to be followed by the participants.

11. The kit of claim 10 further including the step of displaying a picture of a goal to be achieved by the activity by providing an actual size template on which the jigsaw pieces are to be positioned by the participants.

12. The kit of claim 10 wherein the lesson plan includes the setting of time limits.

13. A method for teaching geography to multiple participants of a map puzzle activity directed by an instructor, the method comprising the steps of:
a) providing a kit for manipulating regional spatial data, which includes,
i. a map puzzle including a plurality of interlocking jigsaw pieces of predetermined shapes each representing geopolitical feature,
ii. a plurality of reusable sticker icons each representing a geographical feature,
iii. a plurality of reusable text labels each expressing a place name,
iv. at least one lesson plan, and
vi. at least one set of instructions;
b) assigning a goal to be achieved by the participants;
c) distributing the jigsaw pieces to the participants;
d) designating a clean flat surface on which a map is to be constructed by the participants by positioning of the jigsaw pieces, and
d) establishing rules of behavior to be followed by the participants.

14. The method of claim 13 wherein the steps further include
displaying a picture of a goal to be achieved by the activity by providing a representational template with reference to which the jigsaw pieces are to be positioned by the participants.

15. The method of claim 13 further including the step of setting a time limit for the activity to be completed.

16. The method of claim 13 wherein the jigsaw pieces are distributed such that some participants are given more than jigsaw pieces than other participants.

17. The method of claim 13 wherein the jigsaw pieces are numerically equally distributed among the participants.

18. The method of claim 13 further including the step of the instructor observing the activity and providing answers to one or more questions related to the behavior of the participants and how the activity was performed.

19. The method of claim 13 wherein the jigsaw pieces comprise interlocking pieces capable of being assembled to form a graphic image of a geographic area and the method includes the step of assembling said interlocking pieces.

20. The method of claim 19 wherein the kit includes reusable sticker icons releasably attachable to the graphic image of the geographic area to identify the location of the geographic feature and the method includes the step of attaching said reusable sticker icons to corresponding interlocking pieces.
